(19) United States
(12) Patent Application Publication
(10) Pub. No.: US 2014/0310216 A1
(43) Pub. Date: Oct. 16, 2014

(54) METHOD FOR GENERATING COMPACT REPRESENTATIONS OF SPIKE TIMING-DEPENDENT PLASTICITY CURVES

(71) Applicant: QUALCOMM Incorporated, San Diego, CA (US)

(72) Inventors: Anthony SARAH, San Diego, CA (US); Jeffrey Alexander LEVIN, San Diego, CA (US)

(73) Assignee: QUALCOMM Incorporated, San Diego, CA (US)

(21) Appl. No.: 14/045,672

(22) Filed: Oct. 3, 2013

Related U.S. Application Data
(60) Provisional application No. 61/812,043, filed on Apr. 15, 2013.

(51) Int. Cl. G06N 3/02

(52) U.S. Cl. CPC G06N 3/02
USPC 706/15

(57) ABSTRACT

A method generates compact representations of spike timing-dependent plasticity (STDP) curves. The method includes segmenting a set of data points into different sections. The method further includes representing at least one section as a primitive and storing parameters of the primitive. The primitive can be a polynomial.

### CROSS REFERENCE TO RELATED APPLICATION

The present application claims the benefit of U.S. Provisional Patent Application No. 61/812,043, filed on Apr. 15, 2013, in the names of Sarah et al., the disclosure of which is expressly incorporated by reference herein in its entirety.

### BACKGROUND

1. Field

Certain aspects of the present disclosure generally relate to neural system engineering and, more particularly, to systems and methods for generating compact representations of spike timing-dependent plasticity (STDP) curves.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. Moreover, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

Researchers of spiking neural networks use variations in the spike timing-dependent plasticity curves in the neural network. The different types of curves may be expressed through different mathematical functions. Researchers may write one set of equations that governs the behavior of some STDP curves and then write another set of equations that governs another STDP curve, and so on. The researchers then use these different equations in conjunction with synapse models to create spiking neural networks to perform a certain task having specific characteristics.

Implementation of the equations governing different STDP curves is usually performed by creating lookup tables (LUTs) in hardware. These LUTs may span hundreds of milliseconds in time. The lookup tables generally include arrays of real numbers. As such, implementation of LUTs may consume large amounts of memory in hardware. For example, a spiking neural network can have ten different STDP curves, with 16 bits of precision for each value in the LUT. In this example, the LUTs span one second (1000 milliseconds). The memory consumed in hardware for the STDP curves in this example would be 20 kilobytes. Thus, creating the LUTs in hardware is very burdensome and expensive.

### SUMMARY

In accordance with aspects of the present disclosure, a method for generating compact representations of a spike timing-dependent plasticity (STDP) set of data points is disclosed. The method includes segmenting the set of data points into different sections. The method also includes representing at least one section as a primitive and storing parameters of the primitive.

In one aspect, a method for approximating an STDP set of data points is disclosed. The method comprises retrieving at least one parameter from memory. The method also includes applying the parameter(s) to a primitive representing at least one segment of the STDP set of data points. The method further includes determining points of the approximated set of data points based on the parameter(s) and the primitive.

In another aspect, an apparatus for generating compact representations of a STDP set of data points is disclosed. The apparatus has a memory and at least one processor coupled to the memory. The processor(s) is configured to segment the set of data points into different sections, represent at least one section as a primitive, and store parameters of the primitive.

In yet another aspect, a computer program product for generating compact representations of a STDP set of data points is disclosed. The computer program product comprises a non-transitory computer-readable medium having program code recorded thereon. The program code comprises program code to segment the set of data points into different sections. The program code also includes program code to represent at least one section as a primitive, and program code to store parameters of the primitive.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network of neurons in accordance with certain aspects of the present disclosure.

FIG. 2 illustrates an example of a processing unit (neuron) of a computational network (neural system or neural network) in accordance with certain aspects of the present disclosure.

FIG. 3 illustrates an example of spike-timing dependent plasticity (STDP) curve in accordance with certain aspects of the present disclosure.

FIG. 4 illustrates an example of a positive regime and a negative regime for defining behavior of a neuron model in accordance with certain aspects of the present disclosure.

FIG. 5A is a block diagram illustrating a method for parameterizing STDP curves in accordance with certain aspects of the present disclosure.

FIG. 5B is a flow diagram illustrating a process for approximating a STDP set of data points in accordance with aspects of the present disclosure

FIGS. 6A-E illustrate examples of approximated STDP curves in accordance with certain aspects of the present disclosure.

FIGS. 7A-B illustrate examples of an approximated STDP curve with optimized curve segment delimiters in accordance with certain aspects of the present disclosure.

FIG. 8 illustrates an example implementation of designing a neural network using a general-purpose processor in accordance with certain aspects of the present disclosure.

FIG. 9 illustrates an example implementation of designing a neural network where a memory may be interfaced with individual distributed processing units in accordance with certain aspects of the present disclosure.

FIG. 10 illustrates an example implementation of designing a neural network based on distributed memories and distributed processing units in accordance with certain aspects of the present disclosure.

FIG. 11 illustrates an example implementation of a neural network in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

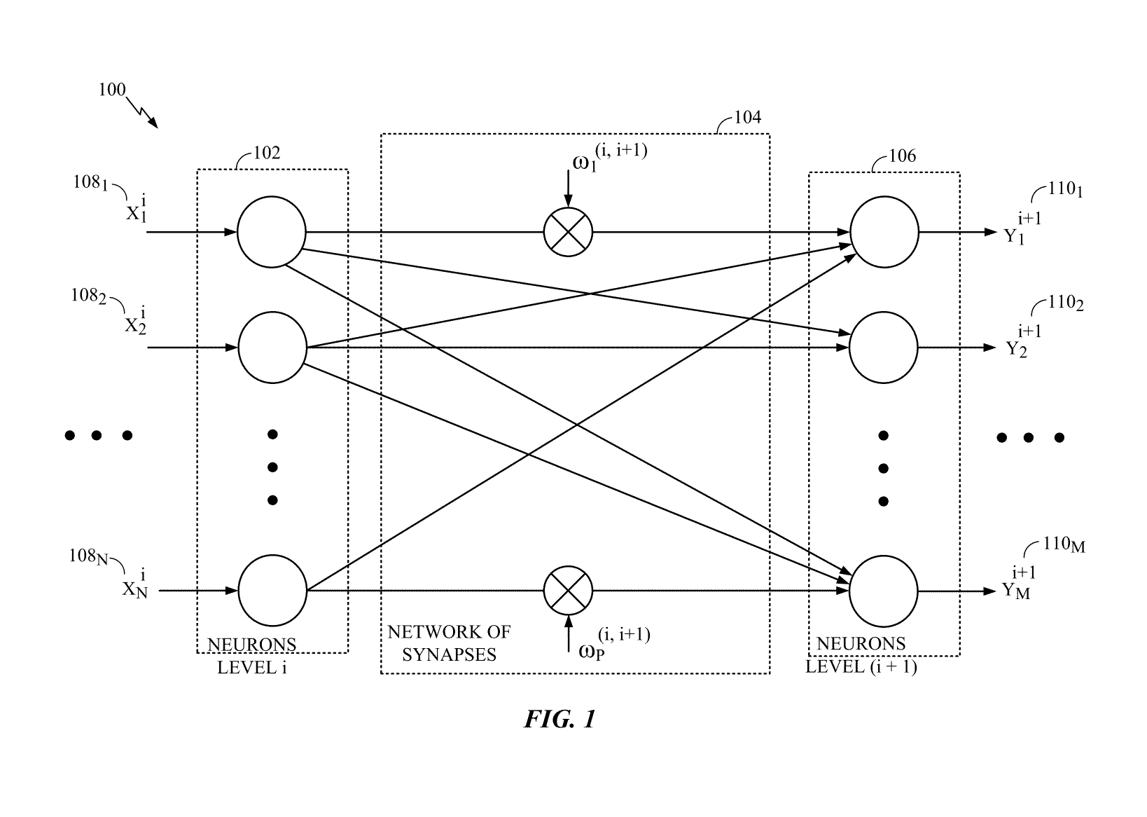

FIG. 1 illustrates an example artificial neural system 100 with multiple levels of neurons in accordance with certain aspects of the present disclosure. The neural system 100 may have a level of neurons 102 connected to another level of neurons 106 through a network of synaptic connections 104 (i.e., feed-forward connections). For simplicity, only two levels of neurons are illustrated in FIG. 1, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by neurons of a previous level (not shown in FIG. 1). The signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). Such behavior can be emulated or simulated in hardware and/or software, including analog and digital implementations such as those described below.

In biological neurons, the output spike generated when a neuron fires is referred to as an action potential. This electrical signal is a relatively rapid, transient, nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal may be represented only by the frequency and number of spikes, or the time of spikes, rather than by the amplitude. The information carried by an action potential may be determined by the spike, the neuron that spiked, and the time of the spike relative to other spike or spikes. The importance of the spike may be determined by a weight applied to a connection between neurons, as explained below.

The transfer of spikes from one level of neurons to another may be achieved through the network of synaptic connections (or simply “synapses”) 104, as illustrated in FIG. 1. Relative to the synapses 104, neurons of level 102 may be considered pre-synaptic neurons and neurons of level 106 may be considered post-synaptic neurons. The synapses 104 may receive output signals (i.e., spikes) from the level 102 neurons and scale those signals according to adjustable synaptic weights w₁^{(i,i+1)}, . . . , w_{P}^{(i,i+1)} where P is a total number of synaptic connections between the neurons of levels 102 and 106 and i is an indicator of the neuron level. In the example of FIG. 1, i represents neuron level 102 and i+1 represents neuron level 106. Further, the scaled signals may be combined as an input signal of each neuron in the level 106. Every neuron in the level 106 may generate output spikes 110 based on the corresponding combined input signal. The output spikes 110 may be transferred to another level of neurons using another network of synaptic connections (not shown in FIG. 1).

Biological synapses may be classified as either electrical or chemical. While electrical synapses are used primarily to send excitatory signals, chemical synapses can mediate either excitatory or inhibitory (hyperpolarizing) actions in postsynaptic neurons and can also serve to amplify neuronal signals. Excitatory signals depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential Inhibitory signals, if strong enough, can counteract the sum of excitatory signals and prevent the membrane potential from reaching a threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, where synaptic weight changes may relate to changes of the memristor resistance. With nanometer feature-sized memristors, the area of a neuron circuit and synapses may be substantially reduced, which may make implementation of a large-scale neural system hardware implementation more practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, where a particular functionality may be based on synaptic weights stored in a memory card currently attached to the neural processor.

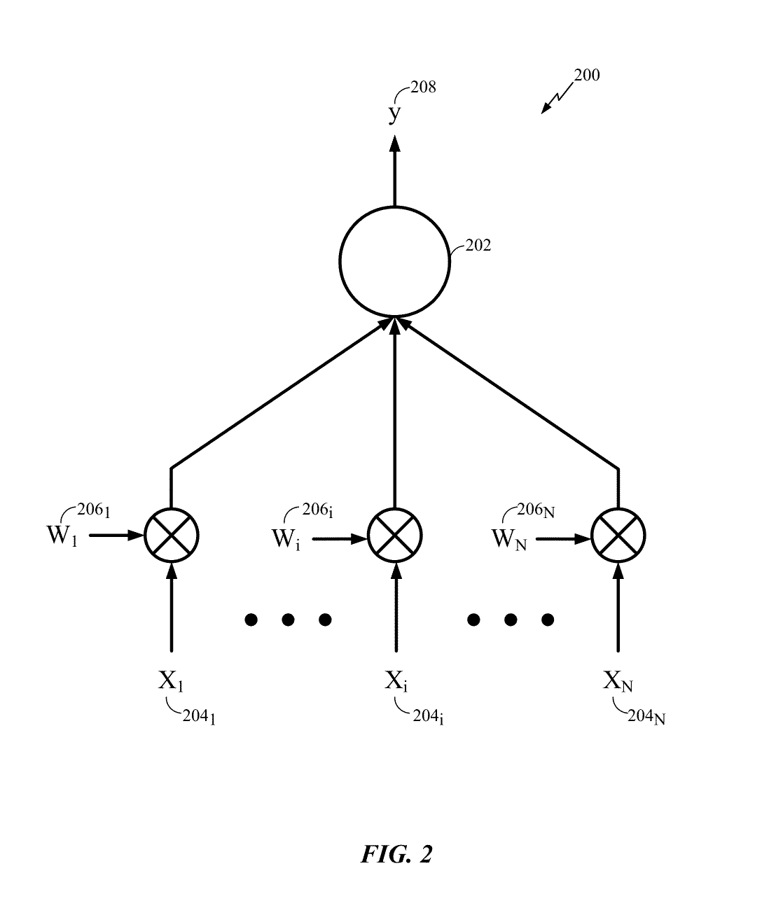

FIG. 2 illustrates an exemplary diagram 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N} (X₁-X_{N}), which may be signals external to the neural system, or signals generated by other neurons of the same neural system, or both. The input signal may be a current or a voltage, real-valued or complex-valued. The input signal may comprise a numerical value with a fixed-point or a floating-point representation. These input signals may be delivered to the neuron 202 through synaptic connections that scale the signals according to adjustable synaptic weights 206₁-206_{N} (W₁-W_{N}), where N may be a total number of input connections of the neuron 202.

The neuron 202 may combine the scaled input signals and use the combined scaled inputs to generate an output signal 208 (i.e., a signal Y). The output signal 208 may be a current, or a voltage, real-valued or complex-valued. The output signal may be a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by electrical connections with synaptic circuits. The processing unit 202 and its input and output connections may also be emulated by a software code. The processing unit 202 may also be emulated by an electric circuit, whereas its input and output connections may be emulated by a software code. In an aspect, the processing unit 202 in the computational network may be an analog electrical circuit. In another aspect, the processing unit 202 may be a digital electrical circuit. In yet another aspect, the processing unit 202 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Those skilled in the art will appreciate that examples of the learning rule include, but are not limited to the spike-timing-dependent plasticity (STDP) learning rule, the Hebb rule, the Oja rule, the Bienenstock-Copper-Munro (BCM) rule, etc. In certain aspects, the weights may settle or converge to one of two values (i.e., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Synapse Type

In hardware and software models of neural networks, the processing of synapse related functions can be based on synaptic type. Synapse types may include non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of multiple types is that processing can be subdivided. For example, non-plastic synapses may not execute plasticity functions (or wait for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables, formulas, or parameters for the synapse's type. Use of varying synapse types may add flexibility and configurability to an artificial neural network.

There are implications of spike-timing dependent structural plasticity being executed independently of synaptic plasticity. Structural plasticity may be executed even if there is no change to weight magnitude (e.g., if the weight has reached a minimum or maximum value, or it is not changed due to some other reason) because structural plasticity (i.e., an amount of delay change) may be a direct function of pre-post spike time difference. Alternatively, structural plasticity may be set as a function of the weight change amount or based on conditions relating to bounds of the weights or weight changes. For example, a synapse delay may change only when a weight change occurs or if weights reach zero but not if they are at a maximum value. However, it may be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike-timing-dependent plasticity.” Consequently, inputs that might be the cause of the post-synaptic neuron's excitation are made even more likely to contribute in the future, whereas inputs that are not the cause of the post-synaptic spike are made less likely to contribute in the future. The process continues until a subset of the initial set of connections remains, while the influence of all others is reduced to an insignificant level.

Because a neuron generally produces an output spike when many of its inputs occur within a brief period, (i.e., inputs being sufficiently cumulative to cause the output), the subset of inputs that typically remains includes those that tended to be correlated in time. In addition, because the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a pre-synaptic neuron to a post-synaptic neuron as a function of time difference between spike time tₚᵣₑ of the pre-synaptic neuron and spike time tₚₒₛₜ of the post-synaptic neuron (i.e., t=tₚₒₛₜ−tₚᵣₑ). A typical formulation of the STDP is to increase the synaptic weight (i.e., potentiate the synapse) if the time difference is positive (the pre-synaptic neuron fires before the post-synaptic neuron), and decrease the synaptic weight (i.e., depress the synapse) if the time difference is negative (the post-synaptic neuron fires before the pre-synaptic neuron).

In the STDP process, a change of the synaptic weight over time may be typically achieved using an exponential decay, as given by:

$$Δ w ( t ) = \{ \begin{matrix}{a}_{+} {e}^{- t / {k}_{+}} + μ , t > 0 \\ {a\_e}^{t / {k}_{-}} , t < 0\end{matrix} , \qquad ( 1 )$$

where k₊ and k₋τ_{sign(Δt)} are time constants for positive and negative time difference, respectively, a₊ and a₋ are corresponding scaling magnitudes, and μ is an offset that may be applied to the positive time difference and/or the negative time difference.

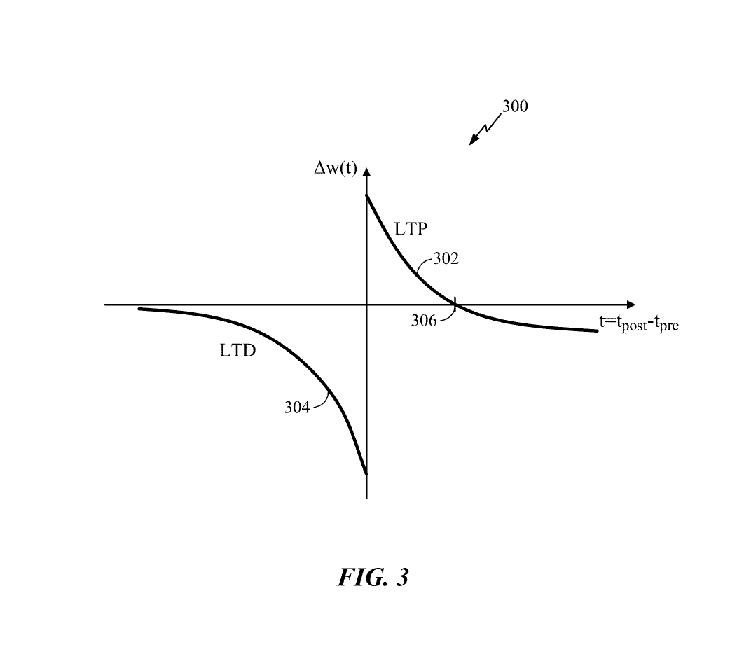

FIG. 3 illustrates an exemplary diagram 300 of a synaptic weight change as a function of relative timing of pre-synaptic and post-synaptic spikes in accordance with the STDP. If a pre-synaptic neuron fires before a post-synaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between pre-synaptic and post-synaptic spike times. The reverse order of firing may reduce the synaptic weight, as illustrated in a portion 304 of the graph 300, causing an LTD of the synapse.

As illustrated in the graph 300 in FIG. 3, a negative offset p may be applied to the LTP (causal) portion 302 of the STDP graph. A point of cross-over 306 of the x-axis (y=0) may be configured to coincide with the maximum time lag for considering correlation for causal inputs from layer i−1. In the case of a frame-based input (i.e., an input that is in the form of a frame of a particular duration of spikes or pulses), the offset value p can be computed to reflect the frame boundary. A first input spike (pulse) in the frame may be considered to decay over time either as modeled by a post-synaptic potential directly or in terms of the effect on neural state. If a second input spike (pulse) in the frame is considered correlated or relevant to a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset p may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding. For example, the arrival time of inputs affects output time and coincidence detection can have a narrow time window. Additionally, to be computationally attractive, a good neuron model may have a closed-form solution in continuous time and stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any), can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics:

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a pre-synaptic neuron m to a post-synaptic neuron n, and yₘ (t) is the spiking output of the neuron m that may be delayed by dendritic or axonal delay according to Δt_{m,n} until arrival at the neuron n's soma.

It should be noted that there is a delay from the time when sufficient input to a post-synaptic neuron is established until the time when the post-synaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.:

$$\begin{matrix}\frac{d v}{d t} = ( k ( v - {v}_{t} ) ( v - {v}_{r} ) - u + I ) \text{/} C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in a biologically-consistent linear fashion. The time constant in the supra-threshold regime, positive by convention, reflects anti-leaky channel dynamics generally driving a cell to spike while incurring latency in spike-generation.

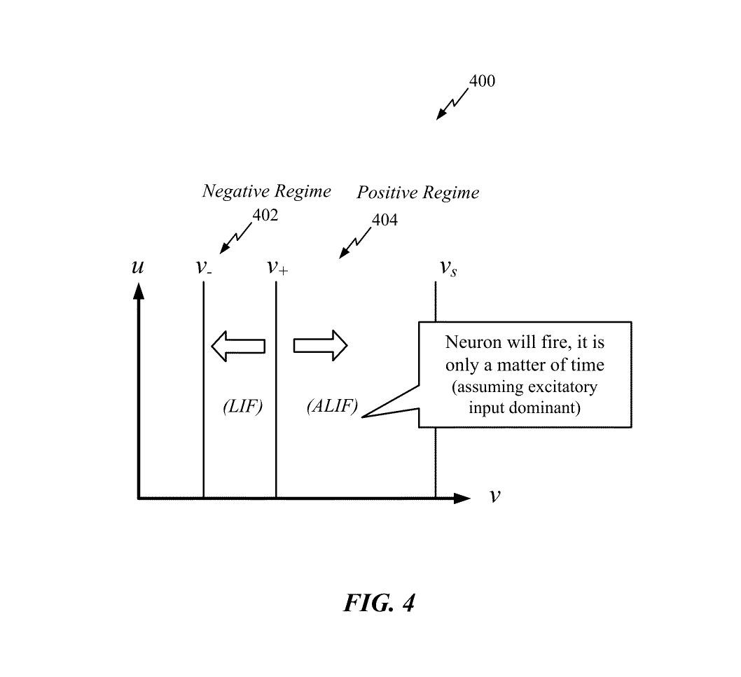

As illustrated in FIG. 4, the dynamics of the model 400 may be divided into two (or more) regimes. These regimes may be called the negative regime 402 (also interchangeably referred to as the leaky-integrate-and-fire (LIF) regime (which is different from the LIF neuron model)) and the positive regime 404 (also interchangeably referred to as the anti-leaky-integrate-and-fire (ALIF) regime, not to be confused with the ALIF neuron model)). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as:

$$\begin{matrix}{τ}_{ρ} \frac{d v}{d t} = v + {q}_{ρ} & ( 5 ) \\ - {τ}_{u} \frac{d u}{d t} = u + r & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are:

q_{ρ}=−τ_{ρ}βu−v_{ρ} (7)

r=δ(v+ε) (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model may be defined to spike when the voltage v reaches a value v_{S}. Subsequently, the state may be reset at a reset event (which may be one and the same as the spike event):

v=\hat{v}₋ (9)

u=u+Δu (10)

where \hat{v}₋ and Δu are parameters. The reset voltage \hat{v}₋ is typically set to v₋.

By a principle of momentary coupling, a closed form solution is possible not only for state (and with a single exponential term), but also for the time required to reach a particular state. The close form state solutions are:

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{- \frac{Δ t}{{τ}_{u}}} - r & ( 12 )\end{matrix}$$

Therefore, the model state may be updated only upon events, such as an input (pre-synaptic spike) or output (post-synaptic spike). Operations may also be performed at any particular time (whether or not there is input or output).

Moreover, by the momentary coupling principle, the time of a post-synaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by:

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches v_{S}, then the closed-form solution for the amount of time, or relative delay, until a spike occurs as measured from the time that the voltage is at a given state v is:

$$Δ {t}_{S} = \{ \begin{matrix}{τ}_{+} log \frac{{v}_{S} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily require iterative methods or Numerical methods. An event-based implementation is also possible at a limited time resolution in a step-based simulator by only updating the model if an event occurs at or between steps or by “step-event” update.

### Compact Representation of STDP Curves

Aspects of the present disclosure are directed to generating compact representations of STDP curves. In one aspect, STDP curves are parameterized. Only parameters are then stored in memory. In another aspect, a number of segment delimiters and locations of those segment delimiters are determined. Although the present description is with respect to curves, any set of data points is contemplated. For ease of illustration, the following description is with respect to curves.

STDP curves are very useful in modeling neuron dynamics and emulating neuron behavior. The different types of curves may be expressed through different mathematical functions. Researchers may write one set of equations that governs the behavior of some STDP curves and then write another set of equations that governs another STDP curve, and so on. The researchers then use these different equations in conjunction with synapse models to create spiking neural networks to perform a certain task having specific characteristics.

However, the implementation of the equations that govern the different STDP curves is usually performed by creating lookup tables (LUTs) in hardware. These LUTs may span hundreds of milliseconds in time and are created using arrays of real numbers. As such, implementation of LUTs may consume large amounts of memory in hardware. To overcome, this obstacle, in accordance with aspects of the present disclosure, an STDP curve may be approximated with a set of polynomial functions of the form:

f(t)=cₙtⁿ+cₙ₋₁tⁿ⁻¹+ . . . +c₁t+c₀ (15)

where cₙ . . . c₀ are the polynomial coefficients and t represents time. Having approximated the curve, the parameters that define the approximated curve may be stored. That is, instead of storing every point of the STDP curve in a lookup table, parameters such as the polynomial coefficients may be stored in memory to represent the STDP curve. In this way, the memory consumed in representing the curve may be greatly reduced.

In some aspects, the polynomial function may be a primitive or an irreducible polynomial. Further, each polynomial function within the set of polynomial functions may approximate a different segment of the STDP curve. Hence, if each polynomial is of order N for each of K segments, then the total number of parameters to be stored may be given by (N+1)K. As such, the amount of space to represent the STDP curve may be reduced. For example, if each coefficient has 16 bits of precision, each polynomial is 7th order (N=7), the STDP curve is partitioned into four segments (K=4) and there are ten different STDP curves then the memory to store the polynomial coefficients would be only 640 bytes. This is substantially less than the approximately 20 kilobytes to store every point of the STDP curves.

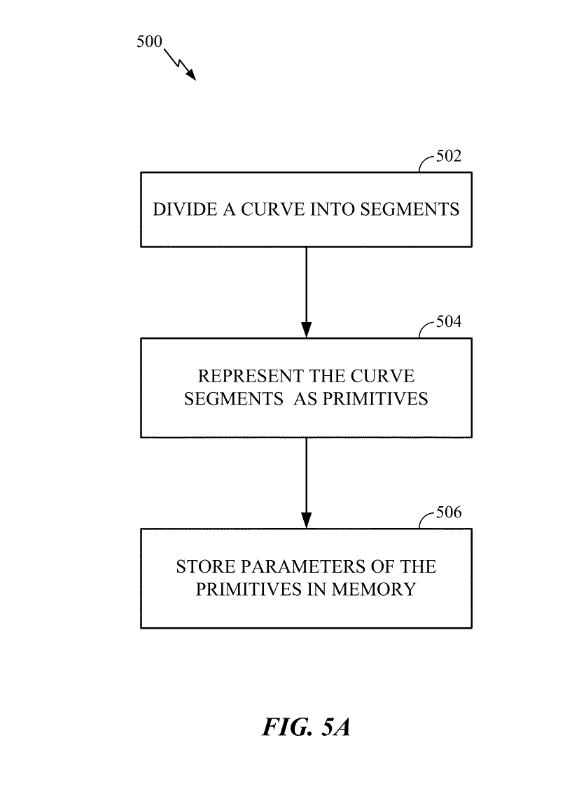

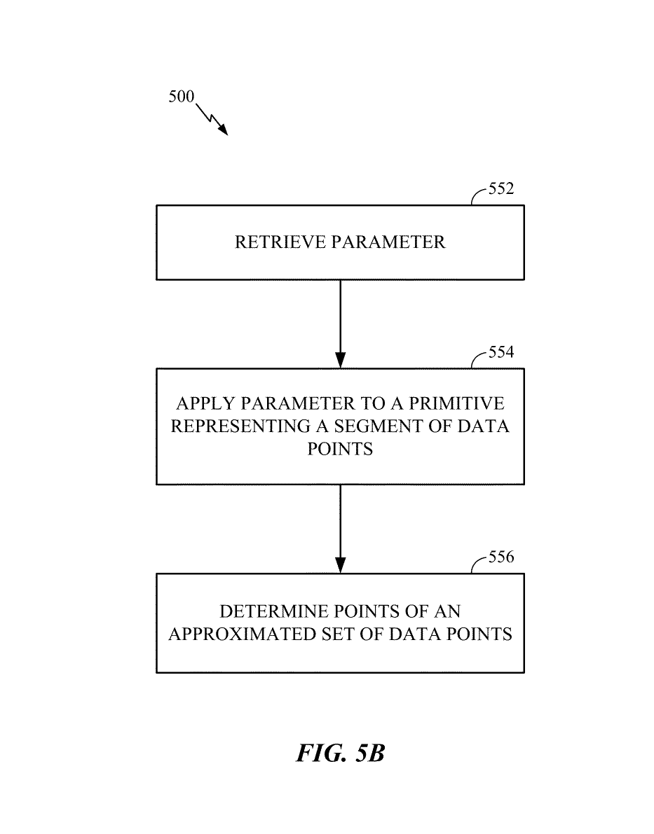

FIG. 5A is a flow diagram 500 illustrating a process for parameterizing an STDP curve. Referring to FIG. 5A, at block 502, the process divides a curve into segments. In some aspects, the process may receive input information defining delimiters or boundaries for the curve segments. For example, the number and location of the delimiters may be manually specified in the input information or may be automatically determined.

At block 504, the process represents the curve segments as primitives. In some aspects, the segments may be represented as a polynomial. Various curve fitting techniques may be employed to approximate each of the curve segments defined by the segment delimiters. In some aspects, the curve defined in each of the curve segments may be approximated using curve fitting techniques based on the number of parameters to be stored. For example, when accuracy of the curve fit is not as critical, a primitive or a lower order polynomial for representing the curve segment may be selected. Because the number of parameters to be stored may be given by (N+1)K where N is the order of the primitive or polynomial representing the curve segment and K is the number of segments, when a lower order polynomial is used, fewer parameters are stored and memory consumption may be reduced.

In some configurations, the primitive or polynomial order N may be specific to the segment in which it is approximating the STDP curve. For example, an approximation with K segments will have K polynomials each of which may have a different order.

In some configurations, the primitive or polynomial may be represented as a piecewise constant. That is, a parameterized STDP curve may be represented using 0th order polynomials (N=0). The primitive or polynomial may also be represented as a piecewise linear model using 1st order polynomials (N=1) or may be represented using splines.

At block 506, the process stores parameters of the primitives in memory. In some aspects, the process may store only parameters such as the coefficients (e.g., cₙ . . . c₀) of the primitives representing each of the curve segments in memory. The primitives representing each of the curve sections may also be stored.

Although the coefficients cₙ . . . c₀ are stored in memory, the coefficients may not remain static. Instead, the coefficients stored in memory may be used to approximate an initial STDP curve and the coefficients may be dynamically modified during simulation of the neural network. The modification may be a function of any number of factors, including but not limited to, firing rate, synaptic weight changes, spike-time distributions, and reward modulators. Thus, the STDP curve may adapt over time.

In some aspects, the coefficients (e.g., cₙ . . . c₀) may also be dynamically updated based on changes in the network. For example, in some configurations, the STDP curve may depend on the spiking rate of a subset of neurons in the network. In this case, the coefficients may be modified dynamically based on spiking statistics gathered during simulation of the network to adapt the STDP curve.

In addition, although the parameterized STDP curves have been described as a mixture of polynomial terms (e.g., c₃t³, c₂t², etc.), the terms used in the combination do not have to be polynomial. Rather, the primitive can be a sum of other terms, including but not limited to, Gaussians, sinusoids, and exponentials terms, may also represent the STDP curves. For example, a mixture of Gaussian terms of the form

$$f ( t ) = ( {c}_{n} \text{?} + {β}_{n} ) + ( {c}_{n - 1} \text{?} + {β}_{n - 1} ) + … + ( {c}_{1} \text{?} + {β}_{1} ) + ( {c}_{0} \text{?} + {β}_{0} ) \\ \text{?} \text{indicates text missing or illegible when filed} \qquad ( 16 )$$

would allow the parameterization of STDP curves with parameters

{cₖ,μₖ,σₖ,βₖ}_{y}=0, . . . ,n

Further, the form of the STDP curve to be parameterized may not be known a priori. Indeed, a curve need not be used. Rather, in accordance with aspects of the present disclosure the method may be applied to empirical data (i.e., raw data) where no analytical expression for the STDP curve is known. For example, where the empirical data is gathered through in vivo experimentation, regression analysis may be performed to estimate the STDP curve. As such, the methods of the present disclosure may be applied directly to the data to simultaneously perform regression and estimation of an STDP curve.

FIG. 5B is a flow diagram 550 illustrating a process for approximating a STDP set of data points in accordance with aspects of the present disclosure. Referring to FIG. 5B, at block 552, the process retrieves a parameter from memory. At block 554, the process applies the parameter to a primitive representing one or more segments of the STDP set of data points. At block 556, the process determines points of an approximated set of data points based on the parameter and the primitive. In some aspects, additional system parameters and/or variables may also be used to determine the points of the approximated set of data points.

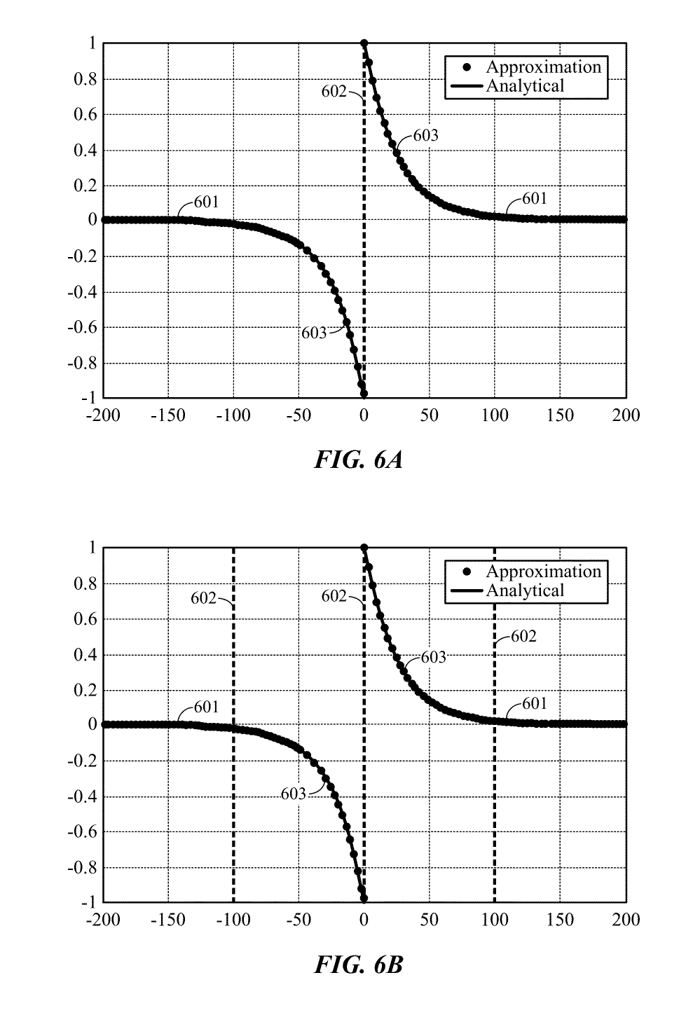

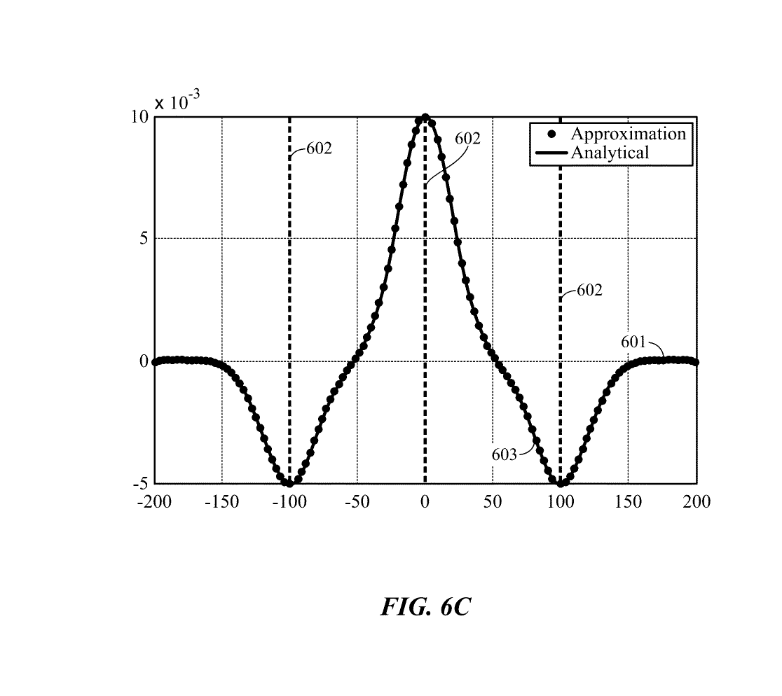

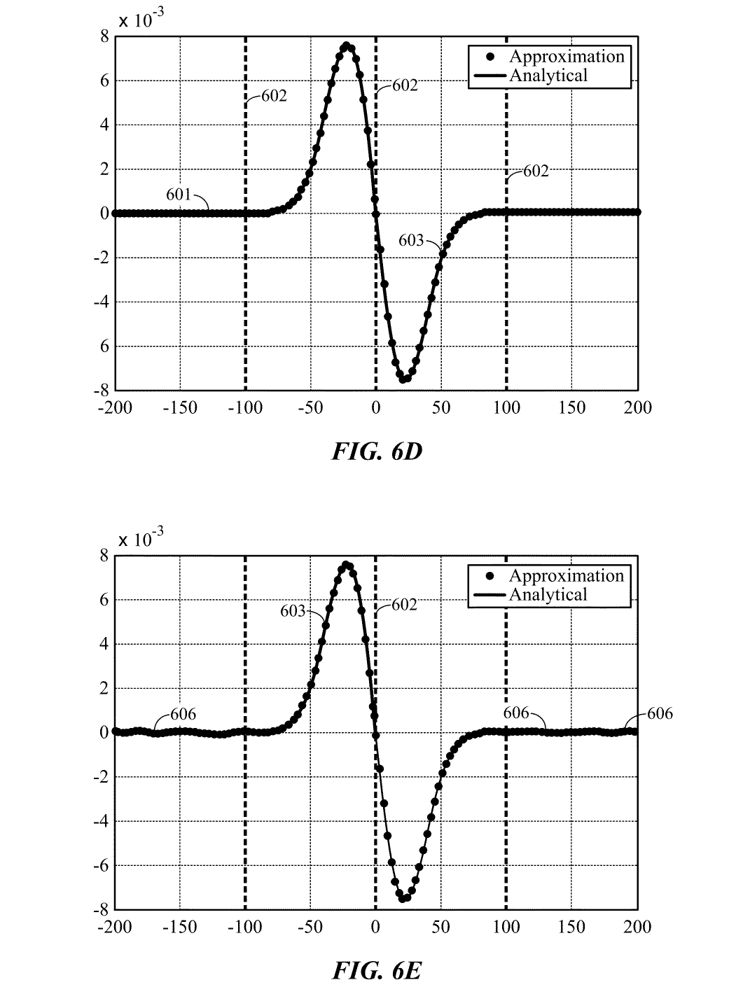

FIGS. 6A-E are exemplary graphs comparing analytical STDP curves with approximated STDP curves in accordance with aspects of the present disclosure. As shown in FIGS. 6A-E, curves of varying complexity are parameterized in accordance with the present disclosure by dividing each of the STDP curves into segments with the segment delimiters 602 and approximating the curves defined in each segment.

FIGS. 6A-B provide an example to illustrate the flexibility of the disclosed method. In some aspects, selecting the number and placement of the segment delimiters may reduce the complexity of the curve segment to be approximated and thus reduce the number of parameters to be stored.

As shown in FIG. 6A, a biologically accurate STDP curve 601 (solid line) may be divided into two segments (K=2) by segment delimiter 602. Each of the curve sections may then be approximated using a 7th order polynomial (N=7). Of course, this is merely exemplary and any order of polynomial for the respective curve section may be selected according to design preference. In this case, the number of parameters to be stored is 16.

On the other hand, in FIG. 6B, the same STDP curve 601 as shown in FIG. 6A is divided into four segments (K=4) by segment delimiters 602. Three segment delimiters 602 are equally spaced apart and symmetrically disposed about 0 ms and equally spaced apart to define four curve segments of equal duration. However, the segment delimiters 602 may not be equally spaced apart. Instead, the segment delimiters 602 may be unevenly spaced or otherwise positioned according to design preference (e.g., to reduce or even minimize memory consumption). Each of the curve segments defined by the segment delimiters 602 may be approximated by using a 3rd order polynomial (N=3). Here, the number of parameters to be stored is also 16. In each case, the approximated curve 603 (dotted lines) substantially matches the STDP curve while storing only 16 parameters.

In FIG. 6C, a more complex STDP curve is approximated in accordance with aspects of the present disclosure. As shown in FIG. 6C, the STDP curve is divided into 4 segments (K=4) with segment delimiters 602. A 5th order polynomial (N=5) may be selected to approximate the curve segments defined by the segment delimiters 602. The approximated curve substantially matches the STDP curve while storing only 24 polynomials coefficients. Although, the approximated STDP curve nearly matches the analytical or ideal STDP curve with only a small amount of approximation error near the tails, the order of the polynomial or the number of segments may be increased to improve the approximation. As such, the approximation errors may be reduced, with additional memory usage.

In FIG. 6D, an STDP curve 601 is divided into 4 segments (K=4) and approximated using 7th order polynomials (N=7). The approximated STDP curve 603 substantially matches the analytical or ideal STDP curve 601 with only 32 polynomial coefficients being stored. On the other hand, in FIG. 6E, the same STDP curve 601 shown in FIG. 6D is divided into only 2 segments (K=2) and approximated using 10th order polynomials. The approximated STDP curve 603 of FIG. 6E shows small approximation error near the tails 606 in comparison to the approximated STDP curve of FIG. 6D, but in this case only 22 polynomial coefficients are stored. Thus, aspects of the present disclosure provide a flexible approach enabling a user to tradeoff-improved accuracy for memory usage.

In some aspects, selection of the number and/or location of the delimiters may be improved or even optimized. That is, the number and location of the delimiters may be determined so as to improve (or even maximize) fidelity in approximating an STDP curve and/or reduce (or even minimize) the memory consumption for a representation. In some aspects, an optimization metric may be defined to quantify the fit of the non-parameterized STDP curve. The optimization metric may be used to determine optimal segment delimiter parameters. For example, the optimization metric may be defined according to the computed sum of squared errors (SSE) and may be given by

$$Ψ ( D ) = {\sum }_{k = 0}^{\vert D \vert - 1} {\sum }_{n = 0}^{{L}_{k - 1}} {( {y}_{k} [ n ] - {f}_{k} [ n ] )}^{2} \qquad ( 17 )$$

where D is the set segment delimiters, Lₖ is the length of segment k, yₖ[n] is the nth value of the parameterized STDP curve in the segment k and fₖ[n] is the nth value of the non-parameterized STDP curve in segment k. Accordingly, the optimization metric (Ψ) quantifies the difference between the parameterized STDP curve and the non-parameterized STDP curve for a given set of segment delimiters D.

The optimal segment delimiter parameters may be determined by

D*=arg_{D}minΨ(D) (18)

The solution for D* may be determined via pattern searching, Simulated Annealing, Simplex Algorithms, Genetic Algorithms and the like.

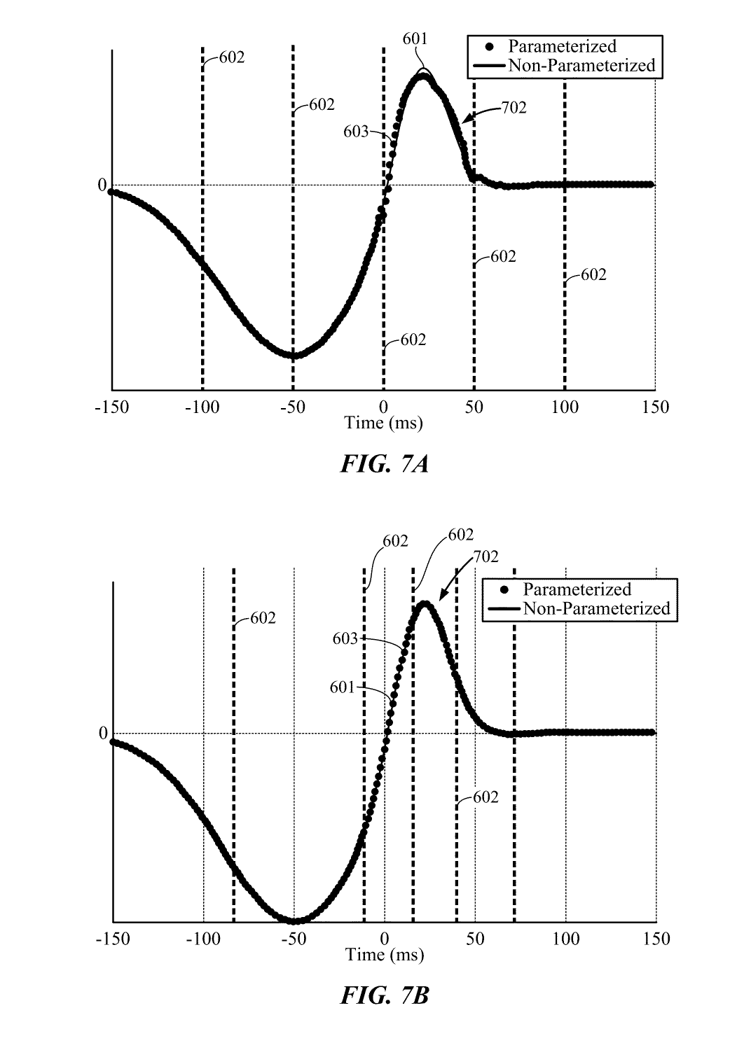

FIGS. 7A and 7B illustrate a segment delimiter optimization in accordance with aspects of the present disclosure. FIG. 7A shows an STDP curve 601, which has been subject to parameterization without optimized segment delimiters. Five segment delimiters divide the STDP curve 601 into six curve segments. The segment delimiters 602 are equally spaced apart and symmetrically disposed about 0 ms. The curve approximation 603 resulting from the parameterized curve 601 is fairly accurate, but noticeably diverges within curve segment four 702.

FIG. 7B illustrates an approximated STDP curve 603 resulting from optimized segment delimiters determined using a pattern search technique. As shown in FIG. 7B, five segment delimiters are still used. However, the segment delimiters are no longer symmetric about 0 ms and are not equally spaced apart. As a result, the fidelity of the approximation is improved, for example, in curve segment four 702.

Thus, by parameterizing STDP curves and determining a number of segment delimiters, as well as locations, a compact representation of an STDP curve can be generated

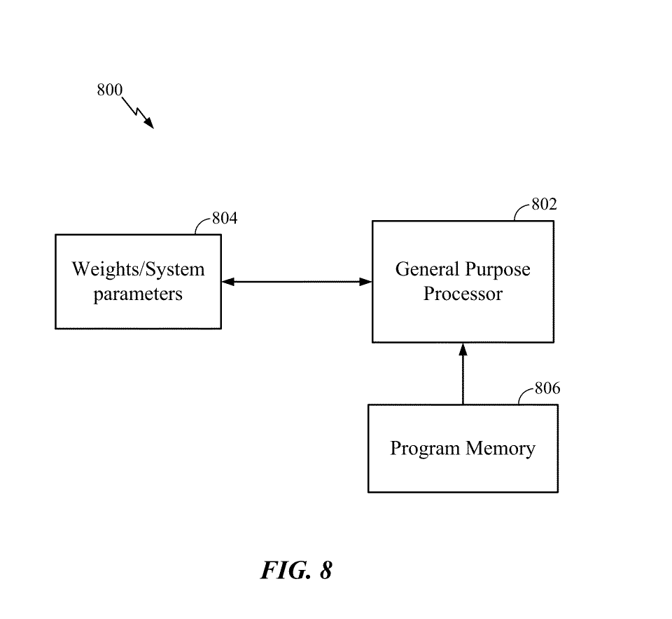

FIG. 8 illustrates an example implementation 800 of the aforementioned method for generating compact representations of STDP curves using a general-purpose processor 802 in accordance with certain aspects of the present disclosure. Coefficients (e.g., cₙ, . . . , c₀), variables (neural signals), synaptic weights, system parameters associated with a computational network (neural network), delay information, and frequency bin information and/or delimiter information may be stored in a memory block 804, while instructions executed at the general-purpose processor 802 may be loaded from a program memory 806. In an aspect of the present disclosure, the instructions loaded into the general-purpose processor 802 may comprise code for generating compact representations of STDP curves.

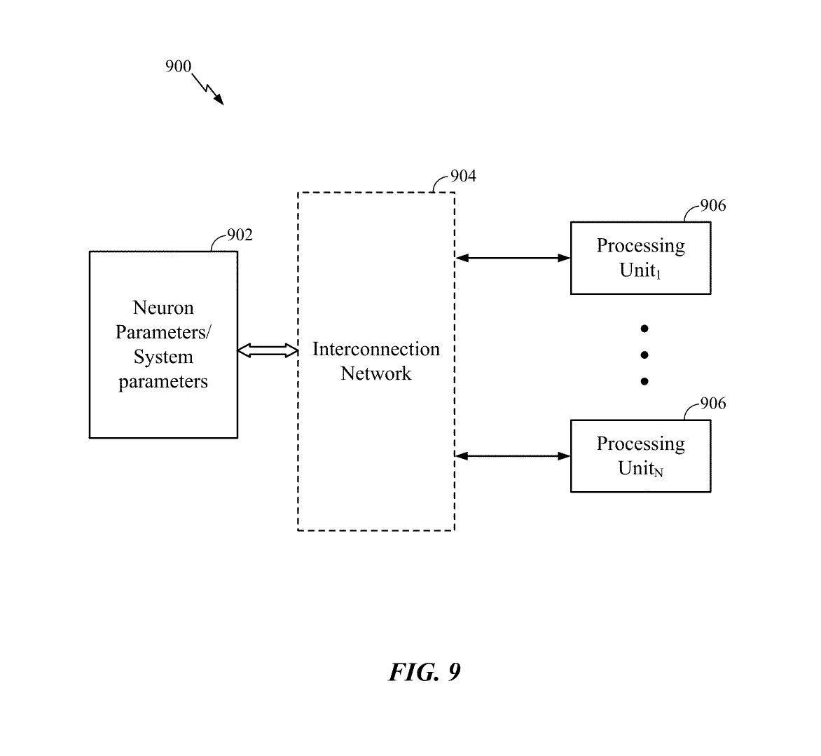

FIG. 9 illustrates an example implementation 900 of the aforementioned method for generating compact representations of STDP curves where a memory 902 can be interfaced via an interconnection network 904 with individual (distributed) processing units (neural processors) 906 of a computational network (neural network) in accordance with certain aspects of the present disclosure. Coefficients (e.g., cₙ, . . . , c₀), variables (neural signals), synaptic weights, system parameters associated with a computational network (neural network), delay information, and frequency bin information or delimiter information may be stored in the memory 902, and may be loaded from the memory 902 via connection(s) of the interconnection network 904 into each processing unit (neural processor) 906. In an aspect of the present disclosure, the processing unit 906 may be configured to generate compact representations of STDP curves.

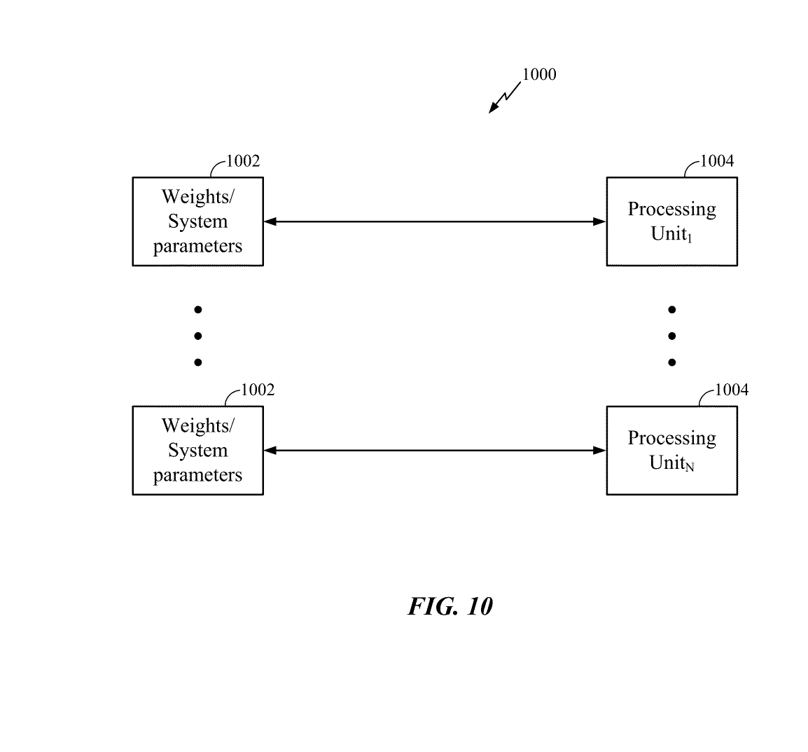

FIG. 10 illustrates an example implementation 1000 of the aforementioned method for generating compact representations of STDP curves. As illustrated in FIG. 10, one memory bank 1002 may be directly interfaced with one processing unit 1004 of a computational network (neural network). Each memory bank 1002 may store coefficients (e.g., cₙ, . . . , c₀), variables (neural signals), synaptic weights and/or system parameters associated with a corresponding processing unit (neural processor) 1004, as well as delay information, frequency bin and/or delimiter information. In an aspect of the present disclosure, the processing unit 1004 may be configured to generate compact representations of STDP curves.

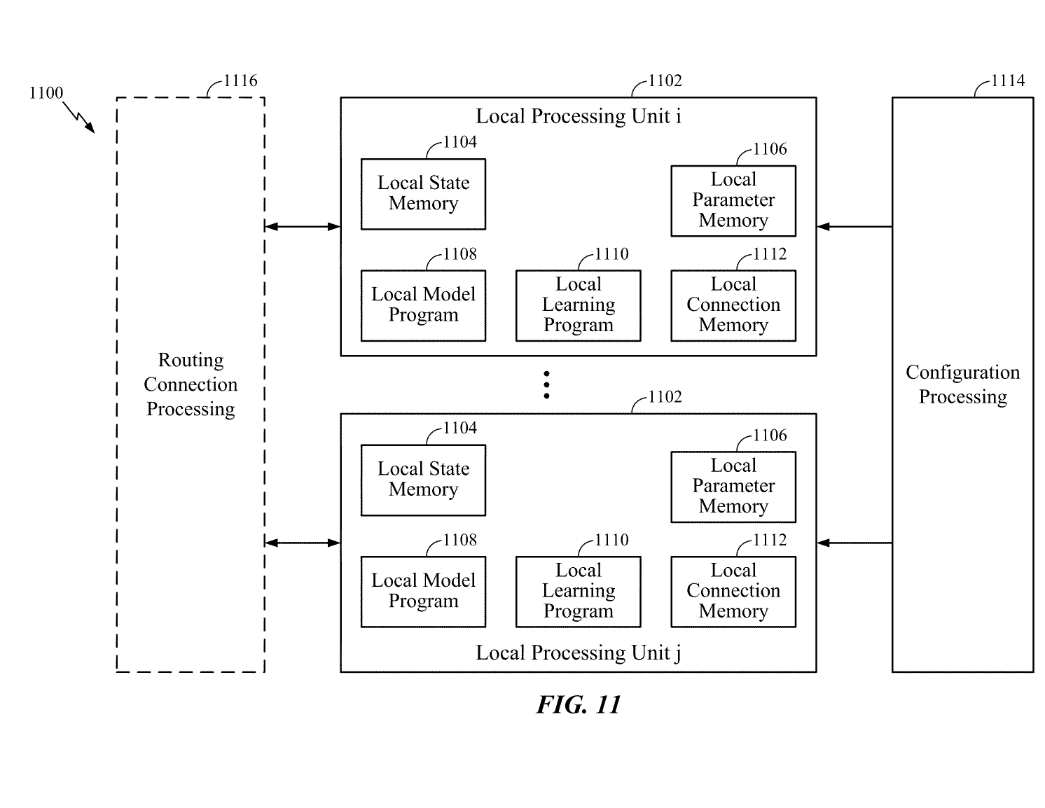

FIG. 11 illustrates an example implementation of a neural network 1100 in accordance with certain aspects of the present disclosure. As illustrated in FIG. 11, the neural network 1100 may have multiple local processing units 1102 that may perform various operations of methods described above. Each local processing unit 1102 may comprise a local state memory 1104 and a local parameter memory 1106 that store coefficients (e.g., cₙ, . . . , c₀) and parameters of the neural network. In addition, the local processing unit 1102 may have a memory 1108 with a local (neuron) model program, a memory 1110 with a local learning program, and a local connection memory 1112. Furthermore, as illustrated in FIG. 11, each local processing unit 1102 may be interfaced with a unit 1114 for configuration processing that may provide configuration for local memories of the local processing unit, and with routing connection processing elements 1116 that provide routing between the local processing units 1102.

According to certain aspects of the present disclosure, each local processing unit 1102 may be configured to determine parameters of the neural network based upon the desired one or more functional features of the neural network, and develop the one or more functional features towards the desired functional features as the determined parameters are further adapted, tuned and updated.

In one configuration, a neuron network is configured to include means for segmenting a STDP set of data points into different sections. The network also includes means for representing at least one section as a primitive, and means for storing parameters of the primitive. The segmenting means, representing means and/or storing means may be the general-purpose processor 802, program memory 806, memory block 804, memory 902, interconnection network 904, processing units 906, memory 1002, processing unit 1004, local processing units 1102, configuration processing 1114, and/or the routing connection processing elements 1116. In another configuration, the aforementioned means may be any module or any apparatus configured to perform the functions recited by the aforementioned means.

In another configuration, a neuron network is configured to include means for segmenting a STDP set of data points into different sections. The network also includes means for representing at least one section as a primitive, and means for storing parameters of the primitive. The segmenting means, representing means and/or storing means may be the general-purpose processor 802, program memory 806, memory block 804, memory 902, interconnection network 904, processing units 906, memory 1002, processing unit 1004, local processing units 1102, configuration processing 1114, and/or the routing connection processing elements 1116. In another configuration, the aforementioned means may be any module or any apparatus configured to perform the functions recited by the aforementioned means.

In yet another configuration, the neural network may include means for retrieving, means for applying, and means for determining. In one aspect, the retrieving means, applying means and/or determining means may the general-purpose processor 802, program memory 806, memory block 804, memory 902, interconnection network 904, processing units 906, memory 1002, processing unit 1004, local processing units 1102, configuration processing 1114, and/or the routing connection processing elements 1116. In another configuration, the aforementioned means may be any module or any apparatus configured to perform the functions recited by the aforementioned means.

That is, the various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the FIG. 5, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. In addition, “determining” may include receiving (e.g., receiving information), accessing (e.g., accessing data in a memory) and the like. Further, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only Memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of generating compact representations of a spike timing dependent plasticity (STDP) set of data points, comprising:
segmenting the set of data points into different sections;
representing at least one section as a primitive; and
storing parameters of the primitive.

2. The method of claim 1, further comprising:
receiving an input value; and
calculating a synaptic weight change from the set of data points based at least in part on the primitive and the received input value.

3. The method of claim 1, in which the at least one section is represented as a linear polynomial equation.

4. The method of claim 1, in which the primitive comprises a spline.

5. The method of claim 1, further comprising changing an effect of a post synapses neuron based on a synaptic weight change.

6. The method of claim 1, in which the primitive comprises a piecewise constant.

7. The method of claim 1, in which the primitive comprises a piecewise linear function.

8. The method of claim 1, further comprising determining boundaries of at least one section.

9. The method of claim 8, in which the determining is based at least in part on an objective function to reduce a difference between a parameterized set of data points and the STDP set of data points.

10. The method of claim 8, further comprising determining a number of sections.

11. The method of claim 1, further comprising representing at least one other section as a primitive type.

12. A method for approximating a spike timing dependent plasticity (STDP) set of data points, the method comprising:
retrieving at least one parameter from memory:
applying the at least one parameter to a primitive representing at least one segment of the STDP set of data points; and
determining points of the approximated set of data points based at least in part on the at least one parameter and the primitive.

13. An apparatus for generating compact representations of a spike timing dependent plasticity (STDP) set of data points, comprising:
a memory; and
at least one processor coupled to the memory, the at least one processor being configured:
to segment the set of data points into different sections;
to represent at least one section as a primitive; and
to store parameters of the primitive.

14. An apparatus for generating compact representations of a spike timing dependent plasticity (STDP) set of data points, comprising:
means for segmenting the set of data points into different sections;
means for representing at least one section as a primitive; and
means for storing parameters of the primitive.

15. A computer program product for generating compact representations of a spike timing dependent plasticity (STDP) set of data points, comprising:
a non-transitory computer-readable medium having program code recorded thereon, the program code comprising:
program code to segment the set of data points into different sections;
program code to represent at least one section as a primitive; and
program code to store parameters of the primitive.

16. An apparatus for approximating a spike timing dependent plasticity (STDP) set of data points, comprising:
a memory; and
at least one processor coupled to the memory, the at least one processor being configured:
to retrieve at least one parameter from memory:
to apply the at least one parameter to a primitive representing at least one segment of the STDP set of data points; and
to determine points of the approximated set of data points based at least in part on the at least one parameter and the primitive.

17. An apparatus for approximating a spike timing dependent plasticity (STDP) set of data points, comprising:
means for retrieving at least one parameter from memory:
means for applying the at least one parameter to a primitive representing at least one segment of the STDP set of data points; and
means for determining points of the approximated set of data points based at least in part on the at least one parameter and the primitive.

18. A computer readable medium for approximating a spike timing dependent plasticity (STDP) set of data points, comprising:
a non-transitory computer-readable medium having program code recorded thereon, the program code comprising:
program code to retrieve at least one parameter from memory:
program code to apply the at least one parameter to a primitive representing at least one segment of the STDP set of data points; and
program code to determine points of the approximated set of data points based at least in part on the at least one parameter and the primitive.
